(19) United States
(12) Patent Application Publication
(10) Pub. No.: US 2003/0119518 A1
(43) Pub. Date: Jun. 26, 2003

(54) Apparatus and method for selecting TTY/TDD baudot code-capable vocoders in a wireless mobile network

(75) Inventors: Joseph Robert Cleveland, Richardson, TX (US); John S. Csapo, Dallas, TX (US); William Joseph Semper, Richardson, TX (US); Philip Sohn, Allen, TX (US)

Correspondence Address: Docket Clerk, P.O. Drawer 800889, Dallas, TX, 75380, US

(73) Assignee: Samusung Electroincs Co. LTD., Paldal-gu (KR)

(21) Appl. No.: 10/033,313

(22) Filed: Dec. 26, 2001

(51) Int. Cl. H04Q 7/20

(52) U.S. Cl. 455/450; 455/560

(57) ABSTRACT

A base station controller in a wireless system is comprised of a set of vocoders that are TTY/TDD Baudot code-capable in addition to the non-TTY/TDD Baudot code-capable vocoders. The base station selects one of the two types of vocoders to communicate with the mobile station based on the capabilities of a mobile station that is communicating with the base station. The mobile station can indicate its capabilities by transmitting its unique identification for use by the wireless system in searching a database of TTY/Baudot code-capable mobile stations. The mobile station can also indicate its capabilities by transmitting Baudot code capability information in an overhead message

### TECHNICAL FIELD OF THE INVENTION

The present invention is directed, in general, to wireless communication networks and, more specifically, to wireless network base stations that selectively assign a vocoder to handle the call traffic of a mobile station depending on the mobile station's capabilities.

### BACKGROUND OF THE INVENTION

The radio frequency (RF) spectrum is a limited commodity. Only a small portion of the spectrum can be assigned to each communications industry. The assigned spectrum, therefore, must be used efficiently in order to allow as many frequency users as possible to have access to the spectrum. Multiple access modulation techniques are some of the most efficient techniques for utilizing the RF spectrum. Examples of such modulation techniques include time division multiple access (TDMA), frequency division multiple access (FDMA), and code division multiple access (CDMA).

CDMA modulation employs a spread spectrum technique for the transmission of information. The CDMA wireless communications system spreads the transmitted signal over a wide frequency band. This frequency band is typically substantially wider than the minimum bandwidth required to transmit the signal. A signal having a bandwidth of only a few kilohertz can be spread over a bandwidth of more than a megahertz.

The wireless communication systems typically use directional antennas located in the center or corners of a cell that broadcast into predetermined sectors of the cell. The cells are located in major metropolitan areas, along highways, and along train tracks to allow end-users to communicate both at home and while traveling.

An end-user of the system typically uses a wireless mobile station to communicate in the wireless communication system. These mobile stations can include cellular radiotelephones, pagers, personal digital assistants, and wireless modems.

All of the mobile stations communicating in the CDMA system transmit on the same frequency. Therefore, in order for the base station to identify each mobile station, each mobile station is assigned a unique pseudo-random (PN) spreading code that identifies that particular mobile to the system. Typically, this PN code is generated using the mobile station's electronic serial number (ESN) that is unique to that mobile station.

Wireless service providers are continually trying to create new markets for wireless mobile stations and to expand existing markets by making mobile stations and services cheaper and more reliable. The price of these wireless devices has been driven down to the point where the devices are affordable to nearly everyone. In fact, the price of a wireless device is only a small part of the total cost to the end-user.

To continue to attract new customers, wireless service providers are concentrating on reducing infrastructure and operating costs. At the same time, the service providers are attempting to improve the quality of wireless service and increase the quantity of services available to the end-user. An example of an additional service needed by wireless service providers is accessibility to the wireless network by hearing-impaired users. Such a service would enable Teletype/Telecommunications Device for the Deaf (TTY/TDD) users who have TTY/TDD Baudot code-capable mobile stations the ability to access the network and communicate with other end users.

The Baudot code is a 45.45 bps signal that is comprised of five data bits that represent a character set limited to upper case letters, numerals, some punctuation, and special codes. The total number of characters is extended from the 32 possible combinations by using two non-printing “shift” codes. Thus each 5-bit code can represent two possible characters; which character a code corresponds to is determined by which shift character was most recently transmitted. Line feed, carriage return, space and the shift codes themselves are exceptions and are common to both the figure and letter character sets.

One problem with providing the TTY/TDD service, however, is that wireless systems typically do not have vocoders that provide TTY/TDD Baudot code accessibility. Additionally, air interface standards (e.g., IS-95 and IS-2000) do not have provisions for such accessibility. Such a service would require a service provider to remove and replace all of the vocoders in the base station controller with vocoders that are Baudot code-capable. This significantly increases the cost of the service provider's infrastructure. Since the TTY/TDD capable mobile stations may be only a small percentage of the total mobile stations in use, the service provider would have a difficult time recouping the costs of providing and maintaining such a service. There is a resulting need in the art for an economical way to provide accessibility to a wireless network by TTY/TDD Baudot code-capable mobile stations.

### SUMMARY OF THE INVENTION

To address the above-discussed deficiencies of the prior art, it is a primary object of the present invention to provide economical TTY/TDD Baudot code communication capabilities to a mobile station in a wireless network.

The present invention encompasses a base station of a wireless network that is capable of communicating with a mobile station located in a coverage area of the wireless network. The base station comprises an apparatus for assigning a vocoder associated with the base station to process call traffic that is associated with the mobile station. The vocoder is selected from either a pool of TTY/TDD Baudot code capable vocoders or a pool of non-TTY/TDD Baudot code capable vocoders.

The apparatus comprises a connection network that is capable of connecting each vocoder to a channel element of a plurality of channel elements. Each of the channel elements is capable of processing forward channel messages transmitted to the mobile station and reverse channel messages received from the mobile station.

The apparatus further comprises a controller that is capable of receiving an overhead message transmitted by the mobile station. The controller extracts from the overhead message a data value suitable for indicating if the mobile station is capable of transmitting and receiving TTY/TDD Baudot code traffic. If the data value indicates that the mobile station is TTY/TDD Baudot code-capable, the controller causes the connection network to connect one channel element to a selected vocoder that is capable of processing TTY/TDD Baudot code traffic. The controller also signals the Mobile Switching Center (MSC) for a preferred connection between the MSC and the selected vocoder.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary wireless network according to one embodiment of the present invention;

FIG. 2 illustrates in greater detail the base station transceiver in the exemplary base station according to one embodiment of the present invention;

FIG. 3 illustrates in greater detail the base station controller in the exemplary base station according to one embodiment of the present invention;

FIG. 4 is a message flow diagram illustrating an operation assigning a vocoder to handle a MOBILE ORIGINATED call according to a first embodiment of the present invention;

FIG. 5 is a message flow diagram illustrating an operation assigning a vocoder to handle a MOBILE TERMINATED call according to a first embodiment of the present invention; and

FIG. 6 is a flow diagram illustrating a vocoder assignment operation according to an exemplary embodiment of the present invention.

### DETAILED DESCRIPTION OF THE INVENTION

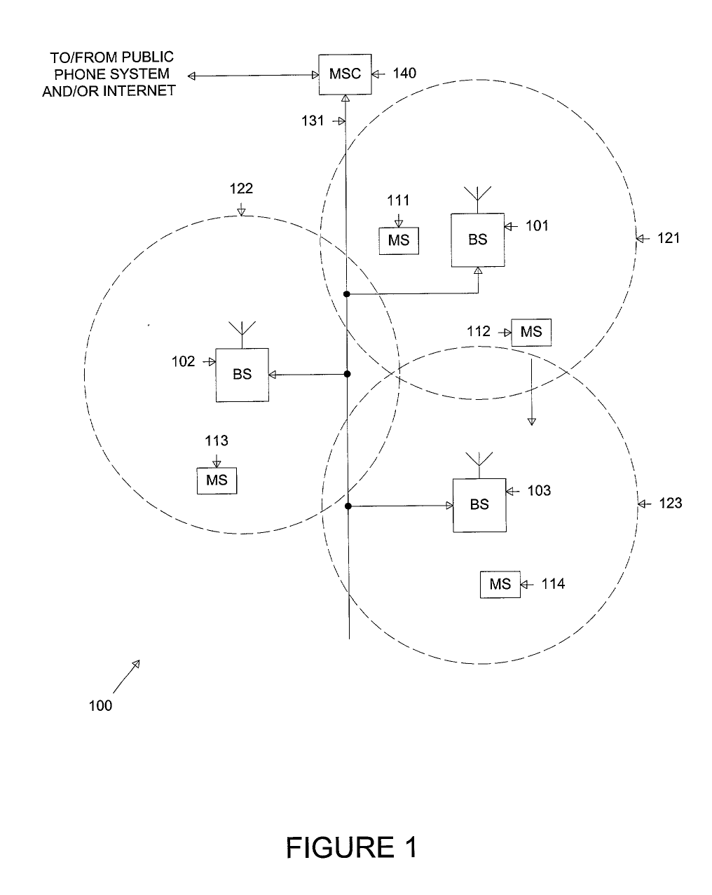

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network base station that uses any air interface standard.

The present invention provides economical accessibility to a wireless network by TTY/TDD Baudot code-capable mobile stations. This is accomplished by providing a set of vocoders in the base station controller (BSC) that are Baudot-capable in addition to the non-Baudot-capable vocoders. The base station then selects one of the two types of vocoders to communicate with the mobile station based on the capabilities of the mobile station. The mobile station can indicate its capabilities in multiple ways including an identification database or overhead messages.

FIG. 1 illustrates exemplary wireless network 100 according to one embodiment of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over, for example, code division multiple access (CDMA) channels, time division multiple access (TDMA) channels, frequency division multiple access (FDMA) channels, or the like. Mobile stations 111-114 may be any suitable wireless devices, including conventional cellular radiotelephones, PCS handset devices, personal digital assistants, portable computers, or metering devices. The present invention is not limited to mobile devices. Other types of access terminals, including fixed wireless terminals, may be used. However, for the sake of simplicity, only mobile stations are shown.

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions. Other embodiments may illuminate the

As is well known in the art, cell sites 121-123 are comprised of a plurality of sectors (not shown), each sector being illuminated by a directional antenna coupled to the base station. The embodiment of FIG. 1 illustrates the base station in the center of the cell. Alternate embodiments position the directional antennas in corners of the sectors. The system of the present invention is not limited to any one cell site configuration.

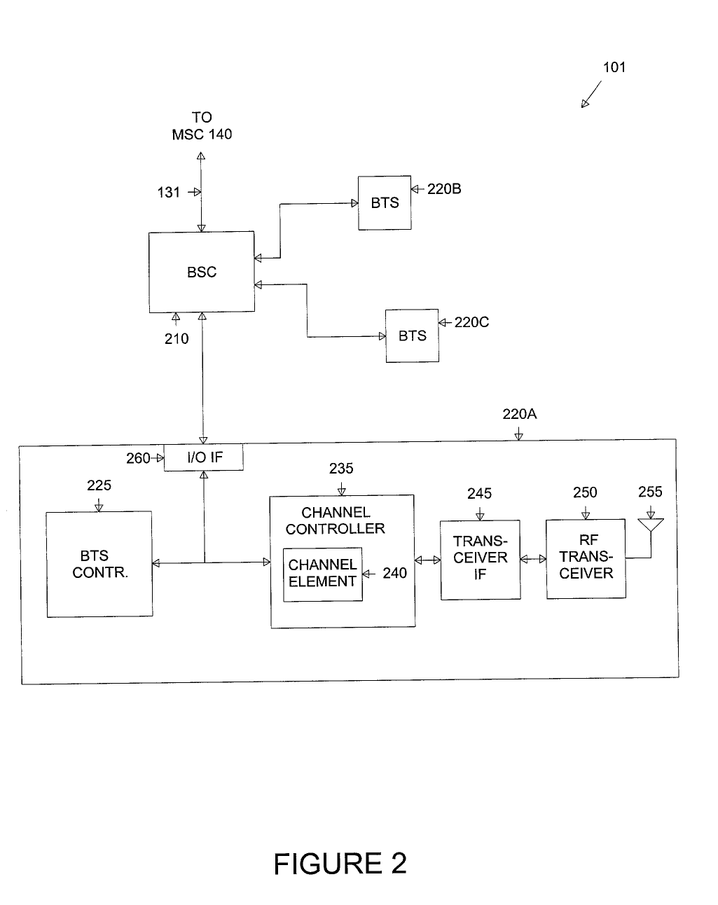

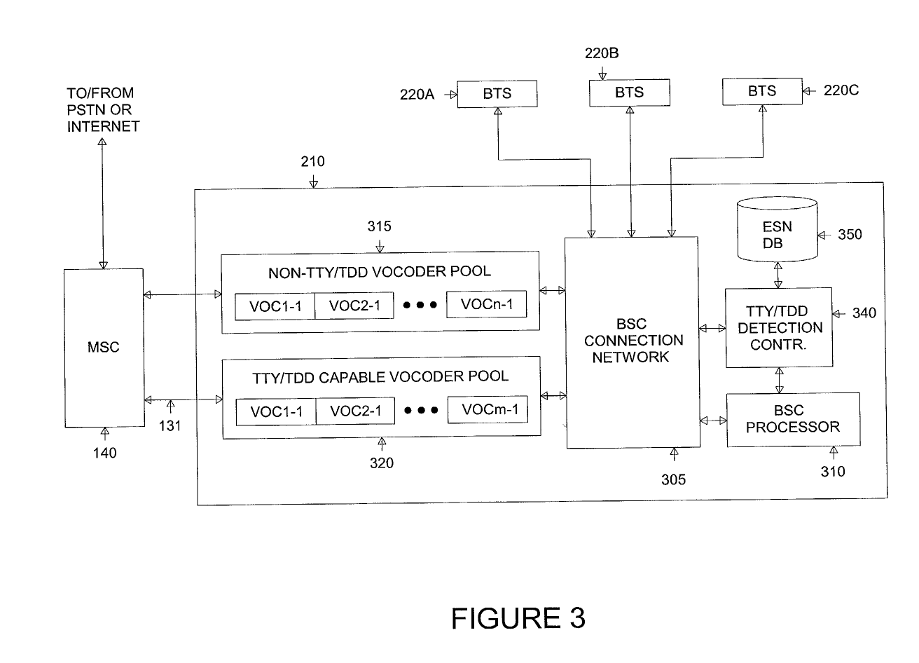

In one embodiment of the present invention, BS 101, BS 102, and BS 103 comprise a base station controller (BSC) and one or more base transceiver station(s) (BTS). Base station controllers and base transceiver stations are well known to those skilled in the art and are illustrated in greater detail in FIGS. 2 and 3.

A base station controller is a device that manages wireless communications resources, including the base transceiver stations, for specified cells within a wireless communications network. A base transceiver station comprises the RF transceivers, antennas, and other electrical equipment located in each cell site. This equipment may include air conditioning units, heating units, electrical supplies, telephone line interfaces, and RF transmitters and RF receivers. For the purpose of simplicity and clarity in explaining the operation of the present invention, the base transceiver station in each of cells 121, 122, and 123 and the base station controller associated with each base transceiver station are collectively represented by BS 101, BS 102 and BS 103, respectively.

BS 101, BS 102 and BS 103 transfer voice and data signals between each other and the public switched telephone network (PSTN) (not shown) via communications line 131 and mobile switching center MSC) 140. Line 131 also provides the connection path to transfers control signals between the MSC and BS 101, BS 102 and BS 103 used to establish connections for voice and data circuits between the MSC and BS 101, BS 102 and BS 103.

Communications line 131 may be any suitable connection means, including a T1 line, a T3 line, a fiber optic link, a network packet data backbone connection, or any other type of data connection. Line 131 links each vocoder in the BSC with switch elements in the MSC. Those skilled in the art will recognize that the connections on line 131 may provide a transmission path for transmission of analog voice band signals, a digital path for transmission of voice signals in the pulse code modulated (PCM) format, a digital path for transmission of voice signals in an Internet Protocol (IP) format, a digital path for transmission of voice signals in an asynchronous transfer mode (ATM) format, or other suitable connection transmission protocol. Those skilled in the art will recognize that the connections on line 131 may a provide a transmission path for transmission of analog or digital control signals in a suitable signaling protocol.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

As is well know, the hand-off procedure transfers control of a call from a first cell site to a second cell site. As MS 112 moves from cell 121 to cell 123, MS 112 detects the pilot signal from BS 103 and sends a Pilot Strength Measurement Message to BS 101. When the strength of the pilot transmitted by BS 103 and received and reported by MS 112 exceeds a threshold, BS 101 initiates a soft hand-off process by signaling the target BS 103 that a handoff is required as described in TIA/EIA IS-95 or TIA/EIA IS-2000.

BS 103 and MS 112 proceed to negotiate establishment of a communications link in the CDMA channel. Following establishment of the communications link between ES 103 and MS 112, MS 112 communicates with both BS 101 and BS 103 in a soft handoff mode. Those acquainted with the art will recognize that soft hand-off improves the performance on both forward (BS to MS) and reverse (MS to BS) links. When the signal from BS 101 falls below a predetermined signal strength threshold, MS 112 may then drop the link with BS 101 and only receive signals from BS 103. The call is thereby seamlessly transferred from BS 101 to BS 103.

The above-described soft hand-off assumes the mobile station is in a voice or data call. An idle hand-off is a hand-off of a mobile station, between cells sites, that is communicating in the control or paging channel.

FIG. 2 illustrates base transceiver station (BTS) 220A in exemplary base station 101 in greater detail according to one embodiment of the present invention. Base station 101 comprises base station controller (BSC) 210 and BTS 220A, 220B, and 220C. Base station controllers and base transceiver stations were described previously in connection with FIG. 1.

BSC 210 manages the resources in cell site 121, including BTS 220A, BTS 220B, and BTS 220C. As described above, BSC 210 is coupled to MSC 140 over data communication line 131. Exemplary BTS 220A comprises BTS controller 225, channel controller 235 that contains channel element 240, transceiver interface (IF) 245, RF transceiver unit 250, and antenna array 255. Input/output interface (I/O IF) 260 couples BTS 220A to BSC 210.

BTS controller 225 controls the overall operation of BTS 220A and interfaces with BSC 210 through I/O IF 260. BTS controller 225 directs the operation of channel controller 235. Channel controller 235 contains a number of channel elements such as channel element 240. The channel elements perform bi-directional communications in the forward and reverse links. Depending on the air interface used by system BS 101, the channel elements engage in time division multiple access (TDMA), frequency division multiple access (FDMA), or code division multiple access (CDMA) communications with the mobile stations in cell 121.

Transceiver IF 245 transfers the bi-directional channel signals between channel controller 235 and RF transceiver 250. Transceiver IF 245 converts the radio frequency signal from RF transceiver 250 to an intermediate frequency (IF). Channel controller 235 then converts this IF to baseband frequency. Additionally, RF transceiver 250 may contain an antenna selection unit to select among different antennas in antenna array 255 during both transmit and receive operations.

Antenna array 255 is comprised of a number of directional antennas that transmit forward link signals, received from RF transceiver 250, to mobile stations in the sectors covered by BS 101. Antenna array 255 also receives reverse link signals from the mobile stations and sends the signals to RF transceiver 250. In a preferred embodiment of the present invention, antenna array 255 is a multi-sector antenna, such as a six-sector antenna, in which each antenna is responsible for transmitting and receiving in a 60_arc of coverage area.

BS 101 of the present invention is not limited to the architecture described above. The architecture may be different depending on the type of air interface standard used by the wireless system. Additionally, the present invention is not limited by the frequencies used. Different air interface standards require different frequencies.

FIG. 3 illustrates, in greater detail, base station controller (BSC) 210 in exemplary BS 101 according to one embodiment of the present invention. BSC 210 is comprised of BSC connection network 305 that couples BTS 220A-220C to BSC 210. BSC connection network 305 is a switch matrix that, under control of BSC processor 310 and TTY/TDD detection controller 340, routes the signals provided by BTS 220A-220C within the BSC.

Two pools of vocoders are illustrated in FIG. 3. Non-TTY/TDD Baudot code-capable vocoder pool 315 represents a set of vocoders that do not have the capability of handling Baudot code. All mobile stations registering with the base station controller that are not Baudot-capable are routed to this pool of vocoders. TTY/TDD Baudot code-capable vocoder pool 320 represents a set of vocoders that have the ability to handle Baudot code. All mobile stations registering with the base station controller that are Baudot-capable are routed to this pool of vocoders.

Both sets of vocoders are coupled to MSC 140 by means of line 131. Line 131 provides a digital path for the transmission of voice signals in the pulse code modulated (PCM) format between each vocoder and the switch elements in MSC 140. MSC 140 is then coupled to the PSTN, Internet, or other network as described above with reference to FIG. 1.

ESN database 350 represents a database of the electronic serial numbers, or other identifying information, of the Baudot code-capable mobile stations that may access the wireless system 100. In one embodiment, the database may be comprised of ESNs of only the Baudot-capable mobile stations that are provided service by the wireless service provider. In this case, the wireless service provider only needs to track those ESNs for Baudot-capable mobile stations for which it has service contracts. In another embodiment, the database stores the ESNs of any Baudot-capable mobile station that has the capability of registering with the wireless system. For example, if the wireless system is a CDMA air interface type system, the database stores the ESNs of all Baudot-capable mobile stations that have a CDMA mode.

In yet another embodiment, ESN database 350 represents a collection of multiple databases from other wireless networks. These databases may be coupled together through data transmission lines or wireless channels such that the data stored on any one of the databases is available to all such systems.

TTY/TDD detection controller 340 is coupled to ESN database 350, BSC processor 310, and BSC connection network 305. TTY/TDD detection controller 340 is responsible for determining whether the mobile station that is registering with the system has TTY/TDD capabilities. This is accomplished by TTY/TDD detection controller 340 detecting the ESN in the signaling transmitted by the mobile station to the base station controller.

TTY/TDD detection controller 340 performs a look-up operation in ESN database 350. If the ESN is found, TTY/TDD detection controller 340 informs BSC processor 310. BSC processor 310 then instructs BSC connection network 305 to switch the call through the set of TTY/TDD capable vocoders 320 and signals the MSC for a preferred connection on line 131 between the MSC and the selected vocoder. If the ESN is not found in ESN database 350, the call is switched through the set of non-TTY/TDD capable vocoders 315. In one embodiment of the invention, the MSC signals the BSC for the preferred switch-vocoder link across line 131.

While the preferred embodiment of the present invention uses the unique ESNs of the mobile stations to perform the vocoder selection, other embodiments use other forms of identifying the mobile station as Baudot-capable. As discussed subsequently, one such embodiment uses information included in the overhead messages transmitted from the mobile station to the base station. Still other embodiments use the user's telephone number or a code entered by the user.

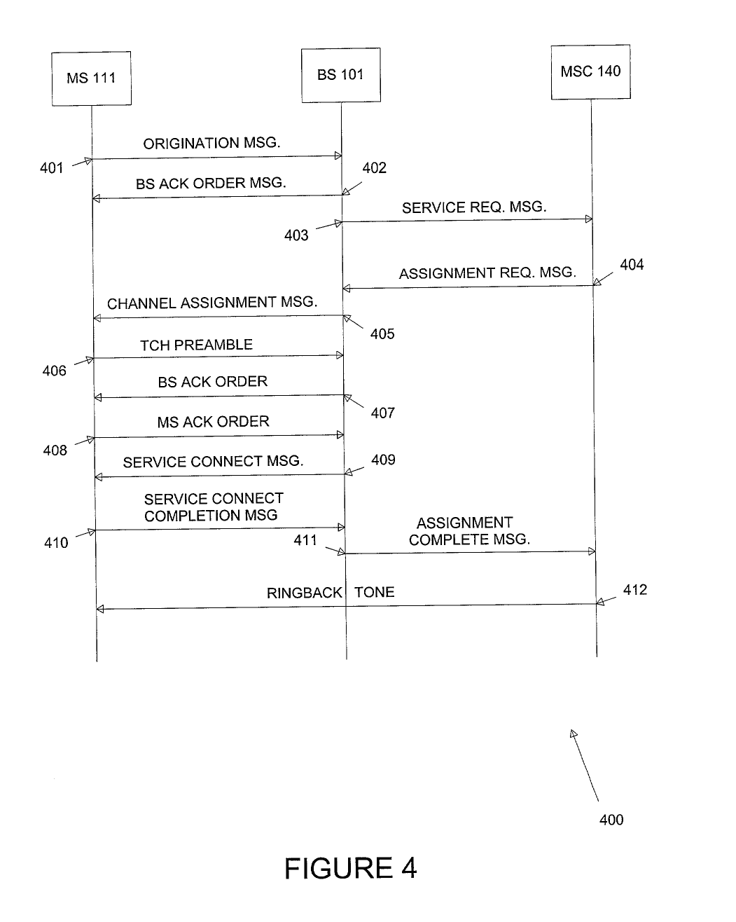

FIG. 4 depicts message flow diagram 400 that illustrates an operation assigning a vocoder to handle a call according to a first embodiment of the present invention. This embodiment assigns the vocoder based on the mobile station indicating that it is Baudot-capable using an identification that is stored in a database or through an overhead message.

The process begins with MS 111 transmitting an origination message 401 over an access channel to BS 101. This message requests service from the wireless system. This message may include information regarding the TTY/TDD capabilities of the mobile station.

Upon receipt of Origination Message 401, BS 101 searches the identification database to determine if MS 111 is equipped for TTY/TDD. As discussed above, this identification, in the preferred embodiment, is based on the mobile station's ESN. In the alternative, BS 101 determines the mobile station's capabilities from the information in Origination Message 401.

If MS 111 is Baudot-capable, BS 101 assigns a Baudot-capable vocoder for call set-up. If MS 111 is not Baudot-capable, a non-Baudot-capable vocoder is assigned for call set-up. BS 101 acknowledges the receipt of origination message 401 with a base station acknowledgment order 402 back to MS 111.

BS 101 then constructs a Service Request Message 403. If the call requires the capability to transport TTY/TDD Baudot codes, BS 101 requests, in Service Request Message 403, that the MSC allocate a circuit on line 131 that is connected to a Baudot-capable transcoder or vocoder according to one embodiment of the present invention. Service Request Message 403 is then transmitted to MSC 140. Those skilled in the art will recognize that the circuit on line 131 may be a 64 kbps DS0 circuit, an asynchronous transfer mode (ATM) virtual circuit, a point-to-point protocol (PPP) logical circuit, an Internet Protocol (IP) logical circuit, or other circuit capable of connecting a MSC circuit to a Baudot-capable vocoder.

In one advantageous embodiment, MSC 140 allocates a circuit based on pre-defined ATM addresses known to MSC 140 and BS 101. In another advantageous embodiment, MSC 140 allocates a circuit based on pre-defined IP addresses known to MSC 140 and BS 101, which does not require negotiation between MSC 140 and BS 101 regarding circuit assignment on line 131.

MSC 140 responds to BS 101 with Assignment Request Message 404. This message requests assignment of radio resources is to the call requested by MS 111. Message 404 includes information regarding the terrestrial circuit, if one is to be used between MSC 140 and BS 101.

If the mobile station is Baudot-capable and MSC 140 requests a terrestrial circuit on line 131 that does not connect to a Baudot-capable vocoder or transcoder, BS 101 constructs a CM Service Request Message that includes a preferred terrestrial circuit on line 131 that is connected to a transcoder that supports TTY/TDD. This message is again sent to MSC 140. If PS 101 and MSC 140 cannot agree on a terrestrial circuit assignment after a predetermined number of attempts, the call is dropped.

If BS 101 requested a terrestrial circuit in the CM Service Request Message and MSC 140 can support that terrestrial circuit, MSC 140 uses the same terrestrial circuit in the Assignment Request Message. Otherwise, MSC 140 assigns a different terrestrial circuit.

Those skilled in the art will recognize that the circuit on line 131 may be a 64 kbps DS0 circuit, an asynchronous transfer mode (ATM) virtual circuit, a point-to-point protocol (PPP) logical circuit, an Internet Protocol (IP) logical circuit or other circuit capable of connecting the MSC circuits to the Baudot-capable vocoder.

In one embodiment of the present invention, MSC 140 allocates a circuit based on pre-defined ATM addresses known to MSC 140 and BS 101. In another embodiment, MSC 140 allocates a circuit based on pre-defined IP addresses known to MSC 140 and BS 101, which does not require negotiation between MSC 140 and BS 101 regarding circuit assignment on line 131.

If a traffic channel is available for the call, BS 101 sends Channel Assignment Message 405 over the paging channel of the radio interface using the address of MS 111. This initiates the establishment of a radio traffic channel if MS 111 is not already on a traffic channel.

MS 111 begins sending the traffic channel preamble, TCH Preamble 406, over the designated reverse traffic channel. Once BS 101 acquires the reverse traffic channel, it sends Base Station Acknowledgment Order 407 to MS 111 over the forward traffic channel.

MS 111 acknowledges the reception of the BS Acknowledgment Order 407 by transmitting Mobile Station Acknowledgment Order 408 to BS 101. MS 111 also sends null traffic channel data (Null TCH) data over the reverse traffic channel.

BS 101 then sends Service Connect Message/Service Option Response Order 409 to MS 111 specifying the service configuration for the call. MS 111 then begins processing the traffic in accordance with the specified service configuration.

Upon receipt of Service Connect Message 409, MS 111 responds with Service Connect Completion Message 410 to BS 101. After the radio traffic channel and circuit have both been established and fully interconnected, BS 101 sends Assignment Complete Message 411 to MSC 140 and considers the call to be in the conversation state. As a call progress tone is applied in-band in this case, Ringback Tone 412 is available on the audio circuit path from MSC 140 to MS 111.

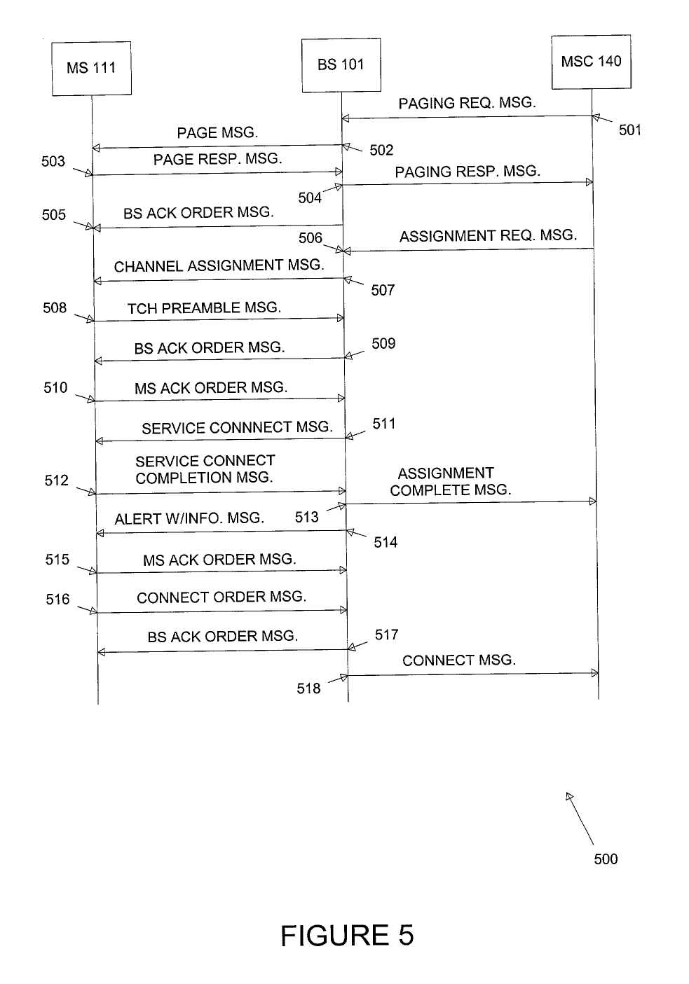

FIG. 5 depicts message flow diagram 500 that illustrates an operation assigning a vocoder to handle a call according to a first embodiment of the present invention. The process begins when MSC 140 determines that an incoming call terminates to a mobile station within its service area. MSC 140 sends a Paging Request Message to BS 101 to initiate a mobile terminated call set-up scenario.

BS 101 issues Paging Message 502, containing the address of MS 111, over the paging channel. MS 111 acknowledges the page by transmitting Page Response Message 503 over the access channel to BS 101. Upon receipt of Paging Response Message 503 from the paged mobile station, BS 101 determines if the paged mobile station requires a vocoder that is capable of transporting TTY/TDD Baudot codes. BS 101 assigns the Baudot-capable vocoder if the mobile station's identification is found in the database or an overhead message indicates this capability.

BS 101 constructs Paging Response Message 504 and sends it to MSC 140. If the mobile station is capable of handling TTY/TDD Baudot code, BS 101 requests that MSC 140 allocate a preferred terrestrial circuit on line 131 to a Baudot-capable transcoder. Those skilled in the art will recognize that the circuit on line 131 may be a 64 kbps DS0 circuit, an asynchronous transfer mode (ATM) virtual circuit, a point-to-point protocol (PPP) logical circuit, an Internet Protocol (IP) logical circuit or other circuit capable of connecting the MSC circuits to the Baudot-capable vocoder.

In one embodiment of the present invention, MSC 140 allocates a circuit based on pre-defined ATM addresses known to MSC 140 and BS 101. In another embodiment, MSC 140 allocates a circuit based on pre-defined IP addresses known to MSC 140 and BS 101, which does not require negotiation between MSC 140 and BS 101 regarding circuit assignment on line 131.

BS 101 acknowledges receipt of Paging Response Message 503 from MS 111 with Base Station Acknowledgment Order 505 to MS 111. At this time, MSC 140 also sends Assignment Request Message 506 to BS 101 to request assignment of radio resources. This message includes a terrestrial circuit if one is to be used between MSC 140 and BS 101 on line 131. Those skilled in the art will recognize that the circuit on line 131 may be a 64 kbps DS0 circuit, an asynchronous transfer mode (ATM) virtual circuit, a point-to-point protocol (PPP) logical circuit, an Internet Protocol (IP) logical circuit or other circuit capable of connecting the MSC circuits to the Baudot-capable vocoder.

In one embodiment of the present invention, MSC 140 allocates a circuit based on pre-defined ATM addresses known to MSC 140 and BS 101. In another embodiment, MSC 140 allocates a circuit based on pre-defined IP addresses known to MSC 140 and BS 101, which does not require negotiation between MSC 140 and BS 101 regarding circuit assignment on line 131.

If BS 101 requested a preferred terrestrial circuit on line 131 in Paging Response Message 504 and MSC 140 can support that terrestrial circuit, MSC 140 uses the same terrestrial circuit specified in Assignment Request Message 506. Otherwise, MSC 140 may assign a different terrestrial circuit on line 131. Those skilled in the art will recognize that the circuit on line 131 may be a 64 kbps DS0 circuit, an asynchronous transfer mode (ATM) virtual circuit, a point-to-point protocol (PPP) logical circuit, an Internet Protocol (IP) logical circuit or other circuit capable of connecting the MSC circuits to the Baudot-capable vocoder.

According to one embodiment of the present invention, MSC 140 allocates a circuit based on pre-defined ATM addresses known to MSC 140 and BS 101. In another advantageous embodiment, MSC 140 allocates a circuit based on pre-defined IP addresses known to MSC 140 and BS 101, which does not require negotiation between MSC 140 and BS 101 regarding circuit assignment on line 131.

BS 101 sends Channel Assignment Message 507 over the control channel of the radio interface using the address of MS 111. This initiates the establishment of a radio traffic channel, if MS 111 is not already on a traffic channel. MS 111 then begins sending the traffic channel preamble, TCH Preamble Message 508, over the designated reverse traffic channel.

Once BS 101 acquires the reverse traffic channel, it sends Base Station Acknowledgment Order 509 to MS 111 over the forward traffic channel. MS 111 acknowledges the reception of the base station order by transmitting Mobile Station Acknowledgment Order 510 to BS 101.

BS 101 then sends Service Connect Message/Service Option Response Order 511 to MS 111 specifying the service configuration for the call. MS 111 begins processing traffic in accordance with the specified service configuration.

Upon receipt Service Connect Message 511, MS 111 responds to BS 101 with Service Connect Completion Message 512. After the radio traffic channel and circuit have both been established, BS 101 sends Assignment Complete Message 513 to MSC 140.

BS 101 sends Alert with Information Message 514 to MS 111 to cause the mobile station to generate an alert tone. MS 111 acknowledges reception of the Alert Message 514 by transmitting Mobile Station Acknowledgment Order 515 to BS 101.

When the call is answered at the mobile station, Connect Order Message 516, with acknowledgment required, is transmitted to BS 101. BS 101 acknowledges Connect Order 516 with the Base Station Acknowledgment Order 517 over the forward traffic channel to the mobile station. BS 101 also sends Connect Message 518 to MSC 140 in order to indicate that the call has been answered at the mobile station. At this point, the call is considered to be stable and in the conversation state.

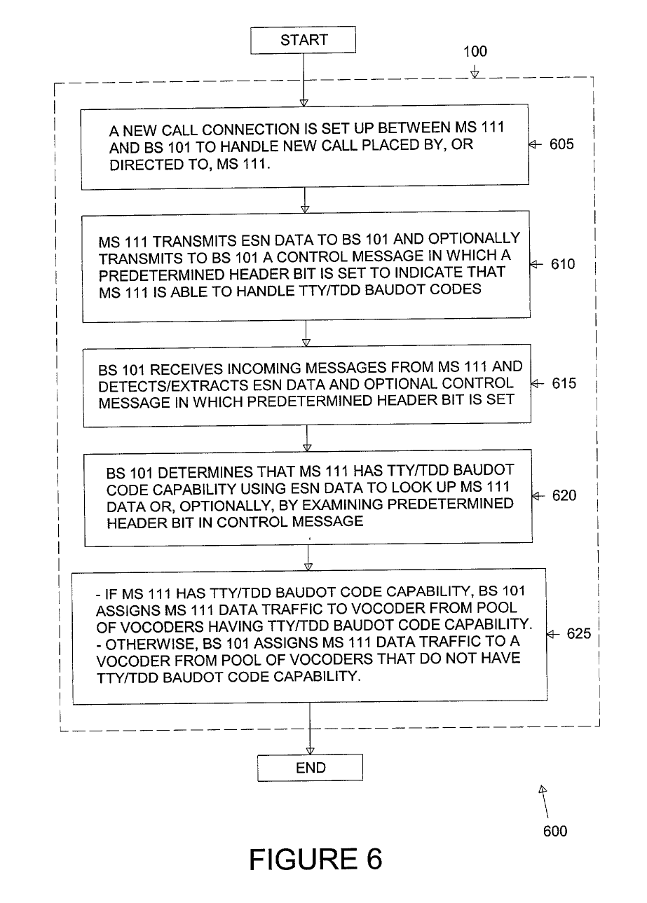

FIG. 6 depicts flow diagram 600 that illustrates a vocoder assignment operation according to an exemplary embodiment of the present invention. Initially, a new call connection is set up between MS 111 and BS 101 to handle a new call placed by, or directed to, MS 111 (process step 605). MS 111 transmits conventional ESN data to BS 101 and, optionally, transmits to BS 101 a control message in which a predetermined header bit is set to indicate that MS 111 is able to handle TTY/TDD Baudot codes (process step 610).

BS 101 receives incoming (i.e., reverse channel) messages from MS 111 and detects and extracts the ESN data and, optionally, the control message in which the predetermined header bit is set (process step 615). ES 111 determines that MS 111 has TTY/TDD Baudot code capability using the ESN data to look up performance data for MS 111 from the ESN database or, optionally, by examining the predetermined header bit in the control message (process step 620).

If MS 111 has TTY/TDD Baudot code capability, BS 101 assigns data traffic to and from MS 111 to a vocoder from the pool of vocoders having TTY/TDD Baudot code capability. Otherwise, BS 101 assigns data traffic for MS 111 to a vocoder from the pool of vocoders that do not have TTY/TDD Baudot code capability (process step 625).

The above-described embodiments assign a Baudot-capable vocoder based on the mobile station identification (e.g., International Mobile Station Identifier (IMSI), ESN, or the like) in a database or an indication bit, word, or section in an overhead message. Other embodiments use other methods to indicate the mobile station's capabilities.

In summary, the present invention enables a wireless service provider to offer TTY/TDD Baudot code services to its subscribers without replacing all of its vocoders or transcoders. The wireless service provider makes a smaller pool of Baudot-capable vocoders/transcoders available, based on the capabilities of each mobile station accessing the system. A Baudot-capable mobile station is then assigned to an appropriate vocoder without any interaction required by an end-user.

Although the present invention has been described in detail, those skilled in the art should understand that they can make various changes, substitutions and alterations herein without departing from the spirit and scope of the invention in its broadest form.

What is claimed is:

1. For use in a base station of a wireless network capable of communicating with mobile stations located in a coverage area of said wireless network, an apparatus for assigning a vocoder associated with said base station to process call traffic associated with a first mobile station, said apparatus comprising:
a connection network capable of connecting a plurality of vocoders to a plurality of channel elements, each of said plurality of channel elements capable of processing forward channel messages transmitted to said first mobile station and reverse channel messages received from said first mobile station; and
a controller capable of receiving an overhead message transmitted by said first mobile station and extracting from said overhead message a data value suitable for indicating if said first mobile station is capable of transmitting and receiving TTY/TDD Baudot code traffic, wherein said controller causes said connection network to connect a first channel element processing forward and reverse channel messages associated with said first mobile station to a first selected vocoder capable of processing TTY/TDD Baudot code traffic if said data value indicates said first mobile station is capable of transmitting and receiving TTY/TDD Baudot code traffic.

2. The apparatus as set forth in claim 1 wherein said data value comprises unique electronic serial number (ESN) data associated with said first mobile station.

3. The apparatus as set forth in claim 1 wherein said data value comprises at least one predetermined data bit of the overhead message.

4. The apparatus as set forth in claim 1 wherein said data value comprises a plurality of bits of the overhead message.

5. The apparatus as set forth in claim 1 wherein said overhead message is an origination message transmitted from said first mobile station to said base station.

6. The apparatus as set forth in claim 1 wherein the plurality of vocoders includes a plurality of non-TTY/TDD Baudot code-capable vocoders such that the plurality of non-TTY/TDD Baudot code-capable vocoders outnumbers the TTY/TDD Baudot code-capable vocoders.

7. The apparatus as set forth in claim 1 wherein said data value comprises unique International Mobile Station Identifier (IMSI) data associated with said first mobile station.

8. The apparatus as set forth in claim 1 wherein said controller causes said connection network to connect a second channel element processing forward and reverse channel messages associated with said first mobile station to a second selected vocoder that is incapable of processing TTY/TDD Baudot code traffic if said data value does not indicate that said first mobile station is capable of transmitting and receiving TTY/TDD Baudot code traffic.

9. A wireless network comprising:
a plurality of base transceiver stations capable of communicating with mobile stations located in a coverage area of said wireless network, wherein a first one of said plurality of base transceiver stations comprises an apparatus for assigning a vocoder associated with said base station to process call traffic associated with a first mobile station, wherein said apparatus comprises:
a connection network capable of connecting a plurality of vocoders to a plurality of channel elements, each of said plurality of channel elements capable of processing forward channel messages transmitted to said first mobile station and reverse channel messages received from said first mobile station; and
a controller capable of receiving a control message transmitted by said first mobile station and extracting from said control message a data value suitable for indicating if said first mobile station is capable of transmitting and receiving TTY/TDD Baudot code data traffic, wherein said controller causes said connection network to connect a first channel element processing forward and reverse channel messages associated with said first mobile station to a first selected vocoder capable of processing TTY/TDD Baudot code data traffic if said data value indicates said first mobile station is capable of transmitting and receiving TTY/TDD Baudot code data traffic.

10. The wireless network as set forth in claim 9 wherein said data value comprises unique electronic serial number (ESN) data associated with said first mobile station.

11. The wireless network as set forth in claim 9 wherein said data value comprises at least one predetermined data bit in an overhead control message.

12. The wireless network as set forth in claim 9 wherein said data value comprises a plurality of, bits of the overhead message.

13. The wireless network as set forth in claim 9 wherein said overhead message is an origination message transmitted from said first mobile station to said base station.

14. The wireless network as set forth in claim 9 wherein the plurality of vocoders includes a plurality of non-TTY/TDD Baudot code-capable vocoders such that the plurality of non-TTY/TDD Baudot code-capable vocoders outnumbers the TTY/TDD Baudot code-capable vocoders.

15. The wireless network as set forth in claim 9 wherein said data value comprises unique International Mobile Station Identifier (IMSI) data associated with said first mobile station.

16. The wireless network as set forth in claim 9 wherein said controller causes said connection network to connect a second channel element processing forward and reverse channel messages associated with said first mobile station to a second selected vocoder that is incapable of processing TTY/TDD Baudot code traffic if said data value does not indicate that said first mobile station is capable of transmitting and receiving TTY/TDD Baudot code traffic.

17. For use in a base station of a wireless network that is capable of communicating with mobile stations located in a coverage area of the wireless network, a method of assigning a vocoder associated with the base station to process call traffic associated with a first mobile station, the method comprising the steps of:
receiving a control message transmitted by the first mobile station;
extracting from the control message a data value suitable for indicating if the first mobile station is capable of transmitting and receiving TTY/TDD Baudot code data traffic; and
if the data value indicates that the first mobile station is capable of transmitting and receiving TTY/TDD Baudot code data traffic, connecting a first channel element processing forward and reverse channel messages associated with the first mobile station to a first selected vocoder capable of processing TTY/TDD Baudot code traffic.

18. The method as set forth in claim 17 wherein the data value comprises unique electronic serial number (ESN) data associated with the first mobile station.

19. The method as set forth in claim 17 wherein the data value comprises at least one predetermined data bit in an overhead control message.

20. The method as set forth in claim 17 wherein the data value comprises unique International Mobile Station Identifier (IMSI) data associated with said first mobile station.

21. The method as set forth in claim 17 and further including the step of:
if the data value does not indicate that the first mobile station is capable of transmitting and receiving TTY/TDD Baudot code data traffic, connecting a second channel element processing forward and reverse channel messages associated with the first mobile station to a second selected vocoder that is incapable of processing TTY/TDD Baudot code traffic.

22. For use in a mobile station that operates in a wireless network that communicates with a plurality of mobile stations located in a coverage area of the wireless network, a method of assigning a vocoder associated with a base station to process call traffic associated with the mobile station, the method comprising the steps of:
the mobile station transmitting a control message comprising a data value that is suitable for indicating whether the mobile station is capable of transmitting and receiving TTY/TDD Baudot code traffic; and
if the data value indicates that the mobile station is capable of transmitting and receiving TTY/TDD Baudot code data traffic, the mobile station communicating with the base station through a first channel element that processes forward and reverse channel messages associated with the first mobile station, the first channel element being coupled to a first selected vocoder that is capable of processing TTY/TDD Baudot code traffic.
